(19) United States
(12) Patent Application Publication
(10) Pub. No.: US 2019/0218102 A1
(43) Pub. Date: Jul. 18, 2019

(54) PROCESS FOR OBTAINING GRAPHENE OXIDE

(71) Applicant: INSTITUTO PRESBITERIANO MACKENZIE, São Paulo (BR)

(72) Inventors: Mauro Cesar Terence, São Paulo (BR); Juan Alfredo Guevara Carrió, São Paulo (BR); Rodrigo Saad do Nascimento, São Paulo (BR)

(21) Appl. No.: 16/313,071

(22) PCT Filed: Jun. 23, 2017
(86) PCT No.: PCT/BR2017/050161

§ 371 Date: Dec. 24, 2018

(30) Foreign Application Priority Data
Jun. 24, 2016 (BR) BR 10 20160149967

(51) Int. Cl. C01B 32/23

(52) U.S. Cl. CPC C01B 32/23

(57) ABSTRACT

The process comprises the following steps: mixing lamellar graphite, containing an intercalating material, with NaNO3 and adding the mixture to a solution of H2SO4 (98%) under continuous stirring; cooling the mixture in an ice bath; adding, very slowly, from 2% to 10% of KMnO4, during a period of time up to 1 h, maintaining the stirring; removing the mixture from the ice bath, heating it and maintaining it under stirring, until the formation of graphene oxide; diluting the mixture in deionized water until the volume of the solution has increased at least 30% and the temperature has not exceeded about 60° C.; leaving the mixture to stand for completing the reaction; heating the mixture between 95° C. and 100° C. and keeping it under high stirring. Adding deionized water and hydrogen peroxide to the mixture, for completion of the oxidation reaction; purifying the mixture by washing it with a solution of HCl and, then, with deionized water, for removing the acids: and filtering and drying the mixture for obtaining the graphene oxide in powder with a conversion degree higher than 90%.

### FIELD OF THE INVENTION

The present invention refers to a process for obtaining graphene oxide from a starting material, defined by graphite in a modified form, to be submitted to oxidation steps derived from the known Hummers method and with the process parameters determined as a function of the new starting material consisting of modified graphite.

### STATE OF THE ART

Graphene oxide is a potential source for obtaining great amounts of graphene, and which has been object of intense research due to its countless properties and applications. Understanding the physical and chemical properties of the graphene oxide is a necessary step to be taken for its functionalization and reduction to graphene.

Moreover, graphene oxide may be used for obtaining nanocomposites with different matrices, promoting a substantial increase of properties. Graphene oxide may also be used in water purification processes for obtaining drinking water.

One of the most widely used methods for the synthesis of graphene oxide in large quantities, for industrial purposes, is the Hummers method (and the modified Hummers method), not only for being carried out more rapidly than other existing methods, but also for being relatively safer.

According to the Hummers method, a sample of graphite is chemically oxidized by being treated with potassium permanganate (KMnO₄) and sodium nitrate (NaNO₃), at a concentration of sulphuric acid (H₂SO₄), in a predetermined sequence, and is subsequently submitted to the addition of deionized water, in order to form the graphene oxide.

Another method has been recently disclosed, comprising the use of a strong oxidant (benzoyl peroxide) and a fine graphite powder for producing graphene oxide. However, said method requires heating at 110° C. and, consequently, extra cares, in order to avoid explosion in a closed recipient. Therefore, the Hummers method is still the most popular one, due to the fact of being safer and easier to carry out.

Ever since the first leaves of graphene were experimentally obtained in 2004, many works have been disclosed, presenting different approaches, uses and methods for treating the graphene (U.S. Pat. No. 8,709,213, U.S. Pat. No. 8,641,998, U.S. Pat. No. 8,691,179, WO2012/167336, US2012/0129736, US2013/0190449 US2914/0147368 and others).

Although the Hummers method (and its variants and modifications) presents the positive aspects cited above, it has been applied by using the graphite having a lamellar structure as a starting material to be oxidized for obtaining the graphene oxide.

The use of the graphite presenting a powder lamellar structure as a starting material does not allow achieving high yield and homogeneity in the oxidation reactions, as a function of the lamellar structure of the graphite itself, which imposes limitations to the degree of exposure of its surface to the oxidation reagents.

The graphene oxide obtained by oxidation of the graphite having a lamellar structure usually in powder, does not allow, due to the inconveniences mentioned above, obtaining, in a simple and at a relatively low cost way, a high quality graphene oxide, due to the degree and homogeneity of oxidation, and of high purity, due to its contents of not completely oxidized graphite portions.

The above limitations are responsible for the high cost of the graphene oxide presenting a high purity degree.

### SUMMARY OF THE INVENTION

As a function of the limitations presented by the known methods for obtaining graphene oxide from lamellar graphite, it is an object of the present invention to provide a process for obtaining graphene oxide, which allows, at a substantially reduced cost, to obtain a final product of high purity, without graphite debris and presenting a high degree of uniform oxidation.

This object is attained through a process for obtaining graphene oxide from a starting material in powder, defined by lamellar graphite with an intercalating material, preferably defined by a polymeric resin, by separating its structural lamellas, submitting said starting material to a sequence of oxidation operations followed by operations of purification, filtration, and drying under vacuum and at room temperature, in order to obtain a graphene oxide in powder form and which is characterized through RAMAN, DRX and FTIR spectroscopy.

### DESCRIPTION OF THE INVENTION

As already mentioned above, the present process uses, as a starting material, lamellar graphite in powder, with its structural lamellas being separated from each other by an intercalating material, preferably defined by a polymer, generally selected among the commercial resins having oxygen in the structure thereof, to be added to the lamellar graphite under high pressures, in order to form a starting material comprising from 80% to 90% of graphite and from 10% to 20% of an intercalating material.

In a way of carrying out the present process, the intercalating material is incorporated to the lamellar graphite by means of the following operations: mechanical mixing and pressurization. The thus formed composite starting material, comprising lamellar graphite and the intercalating material in polymeric resin, for example, may be defined as an industrial residue.

The present process further comprises the steps of oxidizing said starting material, which steps start by the operation of mixing said starting material, in powder, with the same amount of NaNO₃, and adding the mixture to a solution of H₂SO₄ (98%) under continuous stirring, during a period from 1 hour to 2 hours, with the purpose of increasing the reactivity of the mixture.

Subsequently, the mixture is cooled in an ice bath, in order to lower its temperature and maintain it between 20° C. and 25° C., so as to prevent the oxidation rate from increasing, and to maintain the structural integrity of the graphite and of the already formed graphene oxide.

The mixture defined above and maintained between 20° C. and 25° C. receives, very slowly, the addition of an oxidant, such as KMnO₄, during a period of time of no longer than one hour, while maintaining the stirring to prevent the temperature from increasing rapidly and from exceeding an increase of 10° C., in order to avoid the variation in the oxidation rate. In this step of the process, a dark greenish color may be noted in the mixture. The speed of the reaction is controlled to avoid the occurrence of excessive temperature increase.

The mixture is then removed from the ice bath, warmed to temperatures ranging from 20° C. to 30° C. and maintained under stirring, until presenting physical properties indicating the formation of the graphene oxide.

The mixture, in an advanced oxidation process, is diluted with a slow addition of deionized water, until achieving an increase of at least 30% in volume of the original solution, causing a temperature increase, reaching an average of 60° C., and allowed to stand up to 24 hours so that the oxidation reaction may proceed, allowing the liberation of gases and the change of color from the pasty mixture to the brownish or brown color.

The mixture under reaction is then heated until reaching a temperature between 95° C. and 100° C., preferably 98° C., and maintained in this temperature under high stirring, in order to obtain the graphene oxide in suspension and the separation thereof from the polymer and from some other contaminants present in the reaction medium. The oxidation phase further comprises adding deionized water to the reacting mixture, until the solution reaches three times its original volume, said solution further receiving a sufficient amount of hydrogen peroxide for finishing the oxidation reaction.

Upon completion of the oxidation phase of the composite starting material, that is, of the modified lamellar graphite, the oxidized mixture is purified by being washed with a HCL solution for reducing its pH and, subsequently, washed with deionized water for removing the H₂SO₄ and HCl acids.

Then, the resulting oxidized and purified material is filtered(for removing the soluble impurities) and dried, under vacuum and at room temperature, for obtaining graphene oxide in the form of powder, presenting a conversion rate higher than 90%.

The invention allows obtaining graphene oxide in significant amounts, due to the high yield obtained in the reaction through the modification made under determined pressure conditions and in a determined sense, allowing a greater exposure of the surface of the lamellar graphite to the oxidation agents, which increases the reactivity of the graphite to said agents, promoting the oxidation of the starting graphite.

By using the present graphite, besides the advantage already described, that is, high degree of conversion into graphene oxide, value is added to an industrial waste.

The present oxidation process allows obtaining graphene oxide presenting the following characteristics:
High purity without graphite debris; few layers of up to 10-15 micrometers in the lateral dimensions;
Random distribution of the functional groups on the whole surface;
Uniform oxidation in the whole material;
Inter-lamellar distance maintained around 10 Å.

It should be further pointed out that the time for obtaining the graphene oxide is of about 30 hours, including the stand period of 24 hours of the reaction mixture.

1. A process for obtaining graphene oxide, characterized in that it comprises the steps of:
Mixing a powder starting material, defined by lamellar graphite, having an intercalating material separating the structural lamellas thereof, with the same amount of NaNO₃, and adding the mixture to a solution of H₂SO₄ (98%) under continuous stirring, during a period from 1 hour to 2 hours;
Cooling the mixture in an ice bath, in order to lower its temperature and keep it between 20° C. and 25° C.;
Adding, very slowly, from 2% to 10% of an oxidant defined by KMnO₄, for a period of time of up to 1 h, maintaining the stirring to prevent the temperature from increasing rapidly and from surpassing an increase of 10%.
Removing the mixture from the ice bath, heating it and maintaining it under stirring, until it presents physical properties indicating the formation of graphene oxide;
Diluting the mixture by slowly adding deionized water, until reaching an increase of at least 30% in volume of the original solution, causing a temperature increase reaching an average of 60° C.;
leaving the mixture to stand up to 24 h for completion of the reaction.
Heating the mixture until reaching a temperature between 95° C. and 100° C. and maintaining the mixture in said temperature under high stirring;
Adding water to the mixture, until the solution reaches three times its original volume, and also adding to the latter a sufficient amount of hydrogen peroxide for completion of the oxidation reaction;
Purifying the mixture by washing it with HCl solution for reducing the pH thereof and, subsequently, by washing it with deionized for reducing the acids; and
filtering and drying the mixture, under vacuum, and at room temperature, in order to obtain the graphene oxide in powder form presenting a conversion degree higher than 90%.

2. The process, according to claim 1, characterized in that the lamellar graphite, used as a starting material, has the intercalating material of its structural lamellas defined by the addition of a polymer under high pressures.

3. The process, according to claim 2, characterized in that the intercalating polymer is selected among commercial polymers having oxygen in the structure thereof.

4. The process, according to claim 1, characterized in that the starting material comprises from 80% to 90% of graphite and from 10% to 20% of an intercalating material.

5. The process, according to claim 4, characterized in that the intercalating material is incorporated to the graphite through mechanical and pressurization operations.
